(19) United States
(12) Patent Application Publication
(10) Pub. No.: US 2015/0342155 A1
(43) Pub. Date: Dec. 3, 2015

(54) SQUIRREL-PROOF BIRD FEEDER

(71) Applicant: Johnny Dale Fain, Conroe, TX (US)

(72) Inventor: Johnny Dale Fain, Conroe, TX (US)

(21) Appl. No.: 14/293,243

(22) Filed: Jun. 2, 2014

(51) Int. Cl. A01K 39/01

(52) U.S. Cl. CPC A01K 39/0113

(57) ABSTRACT

A method of squirrel-proofing a bird feeder includes identifying a first fixed structure and a second fixed structure. A desired location between the first fixed structure and the second fixed structure is identified. A first end of a first cord is secured to the first fixed structure. A length of the first cord is selected such that the first cord is disposed at an obtuse angle relative to vertical when a second end of the first cord is secured to a mount of the bird feeder disposed at the desired location. A first end of a second cord is secured to the second fixed structure. A length of the second cord is selected such that the second cord is disposed at the obtuse angle relative to vertical when a second end of the second cord is secured to the mount of the bird feeder disposed at the desired location.

### BACKGROUND OF THE INVENTION

Birding, or bird watching, is the observation of wild birds in their natural habitat. Bird feeders may be used to attract wild birds to a particular location for observation. The type of bird feeder and the type of bird feed used varies based on the species of wild birds that you wish to attract. Black-oil sunflower seed is the most common bird feed used in North America because it attracts several indigenous species such as cardinals, chickadees, finches, and sparrows. Other commonly used bird feed includes hulled sunflower seeds, cracked corn, fruit, mealworms, millet, milo, nyjer, oats, peanut hearts, and peanuts. The replenishment of bird feed is expensive and represents a substantial cost associated with the ongoing use of bird feeders.

Conventional bird feeders include ground, hopper, and hanging bird feeders. Ground bird feeders typically provide bird feed at ground level. However, the bird feed is not protected from weather and is vulnerable to consumption by unintended wildlife. Hopper bird feeders typically include some manner of housing that sits on top of a structure that protects the bird feed from weather and certain wildlife. However, the bird feed remains vulnerable to consumption by unintended wildlife. The most common type of bird feeder is the hanging bird feeder. Hanging bird feeders typically include a base, a tube, or a housing, that hangs from a structure and may or may not protect the bird feed from weather. However, the bird feed remains vulnerable to consumption by unintended wildlife.

### BRIEF SUMMARY OF THE INVENTION

According to one aspect of one or more embodiments of the present invention, a method of squirrel-proofing a bird feeder includes identifying a first fixed structure and a second fixed structure. A desired location for a bird feeder in between the first fixed structure and the second fixed structure is identified. A first end of a first cord is secured to the first fixed structure. A length of the first cord is selected such that the first cord is disposed at an obtuse angle relative to vertical when a second end of the first cord is secured to a mount of the bird feeder disposed at the desired location. The second end of the first cord is secured to the mount of the bird feeder. A first end of a second cord is secured to the second fixed structure. A length of the second cord is selected such that the second cord is disposed at the obtuse angle relative to vertical when a second end of the second cord is secured to the mount of the bird feeder disposed at the desired location. The second end of the second cord is secured to the mount of the bird feeder.

According to one aspect of one or more embodiments of the present invention, a squirrel-proof bird feeder includes a bird feeder, a first cord, and a second cord. A first end of the first cord is secured to a first fixed structure and a second end of the first cord is secured to a mount of the bird feeder. The first cord has a length selected such that the first cord is disposed at an obtuse angle relative to vertical when the second end of the first cord is secured to the mount of the bird feeder disposed at a desired location. A first end of the second cord is secured to a second fixed structure and a second end of the second cord is secured to the mount of the bird feeder. The second cord has a length selected such that the second cord is disposed at the obtuse angle relative to vertical when the second end of the second cord is secured to the mount of the bird feeder disposed at the desired location.

Other aspects of the present invention will be apparent from the following description and claims.

### BRIEF DESCRIPTION OF THE DRAWINGS

FIG. 1 shows a squirrel-proof bird feeder in accordance with one or more embodiments of the present invention.

FIG. 2 shows mounting hardware for a squirrel-proof bird feeder in accordance with one or more embodiments of the present invention.

FIG. 3 shows a first cord secured to a first fixed structure in accordance with one or more embodiments of the present invention.

FIG. 4A shows a pulley secured to a second fixed structure in accordance with one or more embodiments of the present invention.

FIG. 4B shows a second cord secured to a second fixed structure in accordance with one or more embodiments of the present invention.

FIG. 5 shows a first cord and a second cord secured to a bird feeder in accordance with one or more embodiments of the present invention.

FIG. 6A shows a user starting the process of lowering a bird feeder in accordance with one or more embodiments of the present invention.

FIG. 6B shows a zoomed in view of a user starting the process of lowering a bird feeder in accordance with one or more embodiments of the present invention.

FIG. 6C shows a user letting out a predetermined length of slack to lower a bird feeder in accordance with one or more embodiments of the present invention.

FIG. 6D shows a zoomed in view of a user letting out a predetermined length of slack to lower a bird feeder in accordance with one or more embodiments of the present invention.

FIG. 6E shows a user replenishing bird feed in a lowered bird feeder in accordance with one or more embodiments of the present invention.

FIG. 6F shows a user starting the process of raising a bird feeder in accordance with one or more embodiments of the present invention.

FIG. 6G shows a user grasping an attachment loop to raise a bird feeder in accordance with one or more embodiments of the present invention.

FIG. 6H shows a user securing the attachment loop to a second fixed structure completing the process of raising the bird feeder in accordance with one or more embodiments of the present invention.

FIG. 7 shows a squirrel-proof bird feeder in accordance with one or more embodiments of the present invention.

FIG. 8 shows a squirrel-proof bird feeder using a first pole as a first fixed structure and a second pole as a second fixed structure in accordance with one or more embodiments of the present invention.

FIG. 9 shows a method of squirrel-proofing a bird feeder in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

Squirrels are small or medium sized rodents in the family Sciuridae that are indigenous to North America, South America, Europe, and Asia. There are approximately two hundred species of squirrels worldwide including some one hundred species of tree squirrels. In North America, the most common species of tree squirrels include the Western Gray squirrel, the Eastern Gray squirrel, the Fox squirrel, and the Red squirrel. Tree squirrels are prolific breeders capable of breeding multiple times per year, producing a litter of one to eight offspring each time they breed. Consequently, the squirrel population has increased dramatically and continues to grow at an alarming rate.

Squirrels are inquisitive, intelligent, and persistent in their search for food sources. Squirrels typically feed during daylight hours seeking out seeds, nuts, cones, fruit, fungi, and/or various types of vegetation. They explore their surroundings at will and are undeterred by the presence of humans. Squirrels exhibit intelligence in the manner in which they seek out food sources. They will often perform a task or series of tasks as part of an effort to gain access to food sources. Once located, squirrels will not relent. They will often use trial-and-error and make a number of attempts to gain access to a food source, even one that is not readily accessible.

In addition to their behavioral characteristics, squirrels possess a number of physical characteristics that aid in their feeding habits. Similar to other rodents, squirrels have large gnawing incisor teeth that grow throughout their lifetime and grinding cheek teeth set back from the incisors. Squirrels use their gnawing incisor teeth to gnaw food or obstacles that impede their access to food sources. They will also use their grinding cheek teeth to grind more rigid food or objects. Squirrels have excellent balance, are agile, and are capable of traversing difficult terrain. They can perform a complex range of maneuvers such as, for example, climb up a tree or object, climb down a tree or object face first, jump up from the ground or a landing to another landing, jump down from above to the ground or a landing, and jump laterally from a landing to another landing. For example, squirrels can jump almost 5 feet in an upward direction from the ground or a landing to another landing. Squirrels can jump almost 5 feet in a downward direction from a landing to the ground or another landing. In certain settings, squirrels can jump almost 10 feet in a lateral direction from one landing to another. As such, squirrels have the means, the motive, and the opportunity to plunder bird feed from bird feeders.

Because of squirrels behavioral and physical characteristics, conventional attempts at squirrel-proofing bird feeders are ineffective. Conventional methods of squirrel-proofing a bird feeder include the use of baffles. Baffles are geometrically-shaped objects disposed on the bird feeder such that the landings presented to the squirrels force the squirrels off of the bird feeder. Dome baffles are often used on the top of hanging bird feeders in an attempt to prevent squirrels from jumping down onto the bird feeder. However, squirrels can often jump onto the bird feeder in a manner that avoids the baffle. If squirrels have access to the bird feeder, the squirrels can shake the bird feeder in such a way that the bird feed falls out of the bird feeder onto the ground. If squirrels have access to a hanging cord that is attached to the bird feeder, they can gnaw on the cord until the bird feeder falls to the ground. As such, baffles are typically not effective in squirrel-proofing a bird feeder and diminish the aesthetic aspects of the bird feeder and the bird watching experience.

Another conventional method of squirrel-proofing a bird feeder includes the use of weight-activated bird feeders that cut off access to bird feed when the weight of a squirrel is detected. Typically, weight-activated bird feeders include a housing that secures the bird feed. A portal provides access to the bird feed and closes when the weight of a squirrel is detected. However, weight-activated bird feeders are not effective in preventing juvenile or small squirrel access. In addition, if squirrels have access to the bird feeder, the squirrels can shake the bird feeder in such a way that the bird feed falls out of the bird feeder onto the ground. If squirrels have access to a hanging cord that is attached to the bird feeder, they can gnaw on the cord until the bird feeder falls to the ground. As such, weight-activated bird feeders are typically not effective in squirrel-proofing a bird feeder and diminish the aesthetic aspects of the bird feeder and the bird watching experience.

Another conventional method of squirrel-proofing a bird feeder includes the use of a bird feeder design that provides physical obstacles to squirrel access. For example, a cage may be disposed around a bird feeder where the pitch of the bars of the cage prevents squirrel access. However, these bird feeders are not effective in preventing juvenile or small squirrel access. In addition, if squirrels have access to the bird feeder, squirrels can shake the bird feeder in such a way that bird feed falls out of the bird feeder onto the ground. If squirrels have access to a hanging cord that is attached to the bird feeder, they can gnaw on the cord until the bird feeder falls to the ground. As such, bird feeder designs that provide physical obstacles to squirrel access are typically not effective and diminish the aesthetic aspects of the bird feeder and the bird watching experience.

In one or more embodiments of the present invention, a squirrel-proof bird feeder prevents squirrel access to bird feed in an aesthetically pleasing manner.

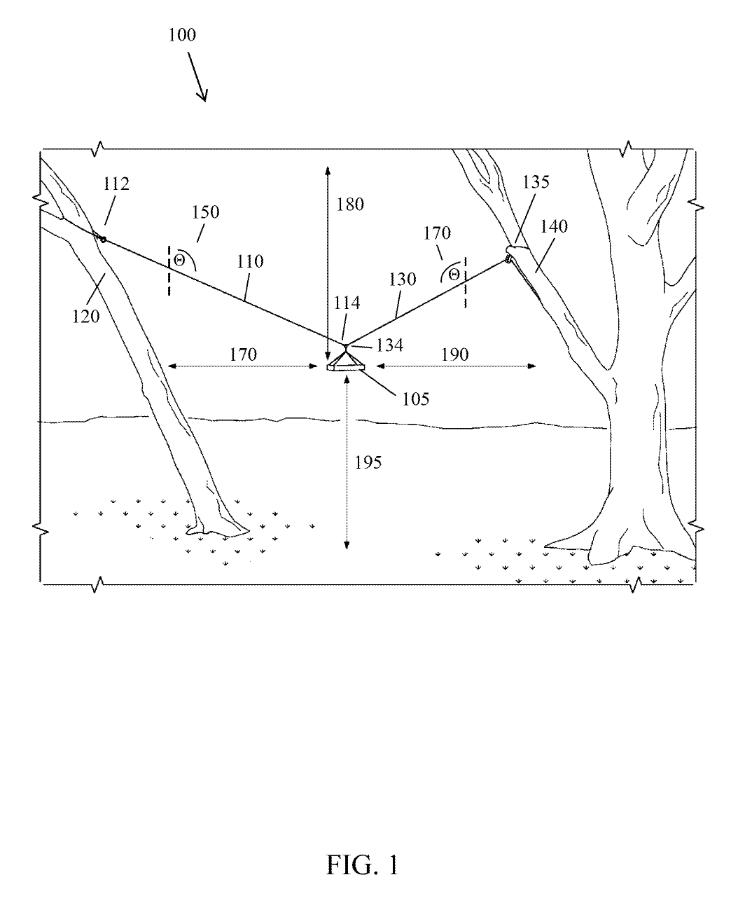

FIG. 1 shows a squirrel-proof bird feeder 100 in accordance with one or more embodiments of the present invention. In certain embodiments, a squirrel-proof bird feeder 100 may include a hanging bird feeder 105, a first cord 110, and a second cord 130. A first end 112 of the first cord 110 may be secured to a first fixed structure 120. In certain embodiments, a ring (not shown) may be attached to the first end 112 of the first cord 110. The first end 112 may be wrapped around the first fixed structure 120 and a second end 114 of the first cord 110 may be threaded through the ring and pulled tight to secure the first end 112 of the first cord 110 to the first fixed structure 120. In other embodiments, the first end 112 of the first cord 110 may be secured to a mount (not shown) disposed on the first fixed structure 120. One of ordinary skill in the art will recognize that the first end 112 of the first cord 110 may be secured to the first fixed structure 120 in other ways in accordance with one or more embodiments of the present invention. In certain embodiments, the first fixed structure 120 may be a tree, shrub, or limb. In other embodiments, the first fixed structure 120 may be a pole or stationary object. One of ordinary skill in the art will recognize that other fixed structures 120 may be used in accordance with one or more embodiments of the present invention.

A second end 114 of the first cord 110 may secured to a bird feeder 105. In certain embodiments, the second end 114 of the first cord 110 may be secured to a mount (not shown) of a snap hook (not shown) that is secured to a mount (not shown) disposed on, or integrated into, bird feeder 105. In other embodiments, the second end 114 of the first cord 110 may be secured directly to the mount disposed on, or integrated into, bird feeder 105. One of ordinary skill in the art will recognize that the second end 114 of the first cord 110 may be secured to bird feeder 105 in other ways in accordance with one or more embodiments of the present invention. The first cord 110 may have a length selected such that the first cord 110 may be disposed at an obtuse angle 150 relative to vertical when the second end 114 of the first cord 110 is secured to the mount disposed on, or integrated into, bird feeder 105, when the bird feeder 105 is positioned in its desired location. In certain embodiments, the obtuse angle 150 may be approximately 150 degrees. In other embodiments, the obtuse angle 150 may be an angle in a range between approximately 145 degrees and approximately 155 degrees. In still other embodiments, the obtuse angle 150 may be an angle in a range between approximately 155 degrees and approximately 165 degrees. In still other embodiments, the obtuse angle 150 may be an angle in a range between approximately 165 degrees and approximately 175 degrees. One of ordinary skill in the art will recognize that the obtuse angle 150 may vary based on an application or design in accordance with one or more embodiments of the present invention.

A first end (not shown) of the second cord 130 may be secured to a second fixed structure 140. In certain embodiments, the first end of the second cord 130 may be secured to the second fixed structure 140 through a mounted 135 pulley system (not independently illustrated). In other embodiments, the first end of the second cord 130 may be secured directly to a mount (not shown) disposed on the second fixed structure 140. One of ordinary skill in the art will recognize that the first end of the second cord 130 may be secured to the second fixed structure 140 in other ways in accordance with one or more embodiments of the present invention. In certain embodiments, the second fixed structure 140 may be a tree, shrub, or limb. In other embodiments, the second fixed structure 140 may be a pole or stationary object. One of ordinary skill in the art will recognize that other fixed structures 140 may be used in accordance with one or more embodiments of the present invention.

A second end 134 of the second cord 130 may secured to bird feeder 105. In certain embodiments, the second end 134 of the second cord 130 may be secured to a mount (not shown) of a snap hook (not shown) that is secured to a mount (not shown) disposed on, or integrated into, bird feeder 105. In other embodiments, the second end 134 of the second cord 130 may be secured directly to the mount disposed on, or integrated into, bird feeder 105. One of ordinary skill in the art will recognize that the second end 134 of the second cord 130 may be secured to bird feeder 105 in other ways in accordance with one or more embodiments of the present invention. The second cord 130 may have a length selected such that the second cord 130 may be disposed at an obtuse angle 170 relative to vertical when the second end 134 of the second cord 130 is secured to the mount disposed on, or integrated into, bird feeder 105, when the bird feeder 105 is positioned in its desired location. In certain embodiments, the obtuse angle 170 may be approximately 150 degrees. In other embodiments, the obtuse angle 170 may be an angle in a range between approximately 145 degrees and approximately 155 degrees. In still other embodiments, the obtuse angle 170 may be an angle in a range between approximately 155 degrees and approximately 165 degrees. In still other embodiments, the obtuse angle 170 may be an angle in a range between approximately 165 degrees and approximately 175 degrees. One of ordinary skill in the art will recognize that the obtuse angle 170 may vary based on an application or design in accordance with one or more embodiments of the present invention.

When bird feeder 105 is disposed at the desired location, the first cord 110 and the second cord 130 are not taut and there is some manner of looseness, or slack, to the cords. The obtuse angle and lack of tautness prevents squirrels from traversing each of the cords. If a squirrel attempts to traverse one of the cords, the obtuse angle and lack of tautness will force the squirrel off balance and they will fall off of the cord. Because the squirrels cannot traverse the cords, they are denied the opportunity of gnawing the mount or hanging cord (not shown) of bird feeder 105.

When bird feeder 105 is disposed at the desired location, there is a minimum lateral clearance from each fixed structure. The minimum lateral clearance may be measured from a center of bird feeder 105 to a fixed structure in a lateral direction. The minimum lateral clearance ensures that squirrels cannot jump laterally from one of the fixed structures 120 or 140 onto bird feeder 105. If a squirrel attempts to jump laterally from one of the fixed structures 120 or 140 onto bird feeder 105, the squirrel will fall short to the ground. In certain embodiments, the minimum lateral clearance from each fixed structure, including clearance 170 and clearance 190, may be approximately 10 feet. In other embodiments, the minimum lateral clearance from each fixed structure may be in a range between approximately 8 feet and approximately 12 feet. In other embodiments, the minimum lateral clearance from each fixed structure may be in a range between approximately 6 feet and approximately 12 feet. One of ordinary skill in the art will recognize that the minimum lateral clearance from each fixed structure may vary based on an application or design in accordance with one or more embodiments of the present invention. One of ordinary skill in the art will also recognize that the minimum lateral clearance from each fixed structure may also vary based on the species of squirrel.

When bird feeder 105 is disposed at the desired location, there is a minimum radial clearance around bird feeder 105 in each radial direction. The minimum radial clearance may be measured from a center of bird feeder 105 outward in a radial manner. The minimum radial clearance ensures that squirrels cannot jump up or down from a fixed structure, the ground, or a landing onto bird feeder 105. If a squirrel attempts to jump up from a fixed structure, the ground, or a landing onto bird feeder 105, the squirrel will fall short to the ground. If a squirrel wishes to jump down from a fixed structure or landing onto bird feeder 105, the minimum radial clearance is outside their comfort zone and they will not attempt the jump. In certain embodiments, the minimum radial clearance around bird feeder 105, including clearance 180 and clearance 195, may be approximately 5 feet. In other embodiments, the minimum radial clearance around bird feeder 105 may be in a range between approximately 4 feet and approximately 6 feet. In other embodiments, the minimum radial clearance around bird feeder 105 may be in a range between approximately 6 feet and approximately 10 feet. One of ordinary skill in the art will recognize that the minimum radial clearance around bird feeder 105 may vary based on an application or design in accordance with one or more embodiments of the present invention. One of ordinary skill in the art will also recognize that the minimum radial clearance around bird feeder 105 may also vary based on the species of squirrel.

In other embodiments (not independently illustrated), a squirrel-proof bird feeder 100 may include a hanging bird feeder 105 and a single cord (not shown). In such an embodiment, a first end (not shown) of the single cord may be secured to the first fixed structure 120 and a second end (not shown) of the single cord may be secured to the second fixed structure 140 as set forth above in one of the various embodiments. In certain embodiments, the single cord may be threaded through a snap hook (not shown) that may then be used to connect to a mount disposed on, or integrated into, bird feeder 105. In other embodiments, the single cord may be threaded through a mount disposed on, or integrated into, bird feeder 105. In still other embodiments, bird feeder 105 may include a mount, such as, for example, a snap hook, that allows it to fasten directly to the single cord. A length of the single cord may be selected such that the single cord is not taut, a first portion (not shown) of the single cord may be disposed at an obtuse angle 150 relative to vertical when bird feeder 105 is disposed at the desired location, and a second portion (not shown) of the single cord may be disposed at the obtuse angle 170 relative to vertical when bird feeder 105 is disposed at the desired location.

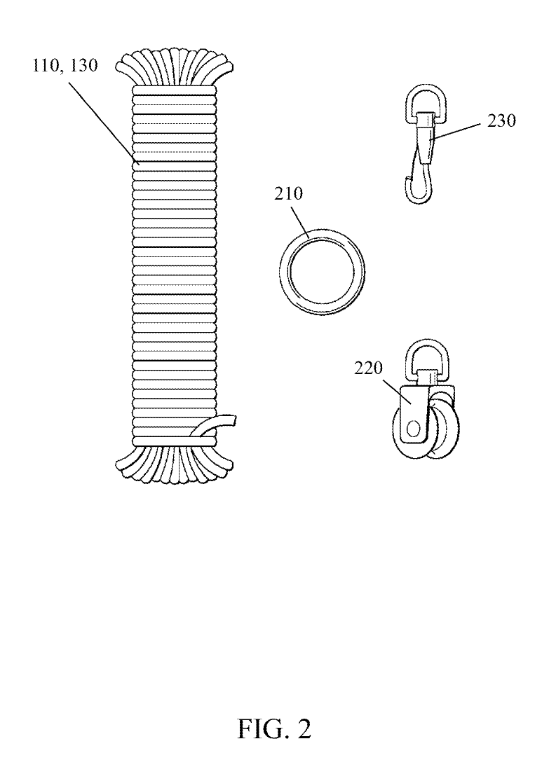

FIG. 2 shows mounting hardware for a squirrel-proof bird feeder in accordance with one or more embodiments of the present invention. The cord segments, such as, for example, first cord 110 and second cord 130, may be composed of rope, twine, or flexible wire made of natural material or fibers, synthetic material or fibers, or combinations thereof, including braided cords. The cord segments may or may not include a sheathing that covers the cord segments. The gauge of the cord segments may impact the visual appearance of the cord segments when birding. Smaller gauge, and certain types of materials, may reduce the visual appearance of the cord segments. In addition, as the gauge decreases, it becomes increasingly difficult for squirrels to traverse the cord segments. In certain embodiments, the cord segments, such as, for example, first cord 110 and second cord 130, may have a gauge of approximately ⅛ inch. In other embodiments, the cord segments may have a gauge smaller than 1/64 inch. In other embodiments, the cord segments may have a gauge in a range between approximately 1/64 inch and approximately ¼ inch. In still other embodiments, the cord segments may have a gauge in a range between approximately ¼ inch and approximately ½ inch.

A ring 210 may be attached to the first end (112 of FIG. 1) of the first cord 110 in embodiments that use ring 210 to secure the first end (112 of FIG. 1) of the first cord 110 to the first fixed structure (120 of FIG. 1). The second end (114 of FIG. 1) of the first cord 110 and the second end (134 of FIG. 1) of the second cord 130 may be secured to a mount of a snap hook 230 in embodiments that use a snap hook 230 to connect to a mount of a bird feeder (105 of FIG. 1). A pulley 220 may be used to secure a first end (not shown) of the second cord (130 of FIG. 1) to the second fixed structure (140 of FIG. 1) in embodiments that use a pulley system to raise and lower the bird feeder (105 of FIG. 1). One of ordinary skill in the art will recognize that additional or other mounting hardware may be used in accordance with one or more embodiments of the present invention.

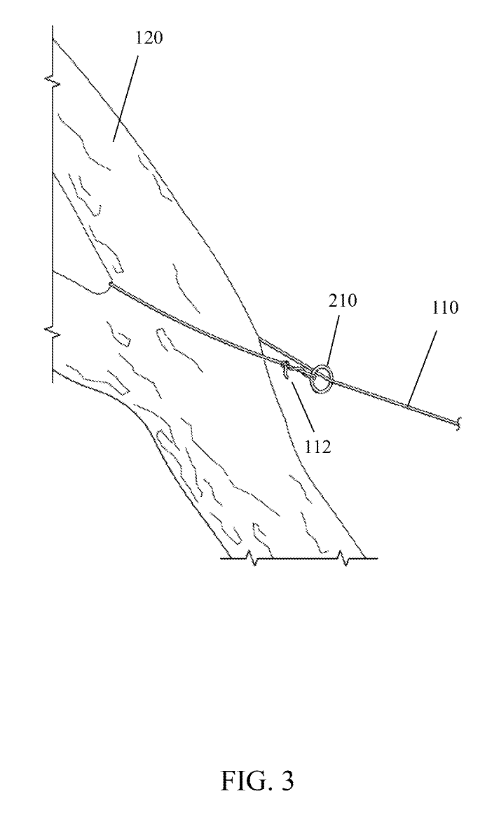

FIG. 3 shows a first end 112 of a first cord 110 secured to a first fixed structure 120 in accordance with one or more embodiments of the present invention. In certain embodiments, a ring 210 may be attached to the first end 112 of the first cord 110. The first end 112 of the first cord 110 may be, for example, tied to ring 210. The first end 112 of the first cord 110 may then be wrapped around the first fixed structure 120, a second end (114 of FIG. 1) of the first cord 110 may be threaded through the ring 210, and the second end (114 of FIG. 1) of the first cord 110 may be pulled through the ring 210 until the first cord 110 is secured to the first fixed structure 120. The second end (114 of FIG. 1) of the first cord 110 may then be secured directly to a mount (not shown) disposed on, or integrated into, a bird feeder (105 of FIG. 1) or secured to a mount (not shown) of a snap hook (230 of FIG. 2) that is secured to a mount (not shown) disposed on, or integrated into, a bird feeder (105 of FIG. 1). In other embodiments (not independently illustrated), a first end 112 of a first cord 110 may be secured to a mount (not independently illustrated) disposed on, or otherwise connected to, the first fixed structure 120. The mount disposed on the first fixed structure 120 may include, for example, a nail (not shown), a screw (not shown), or hook (not shown). One of ordinary skill in the art will recognize that other mounts may be disposed on the first fixed structure 120 in accordance with one or more embodiments of the present invention.

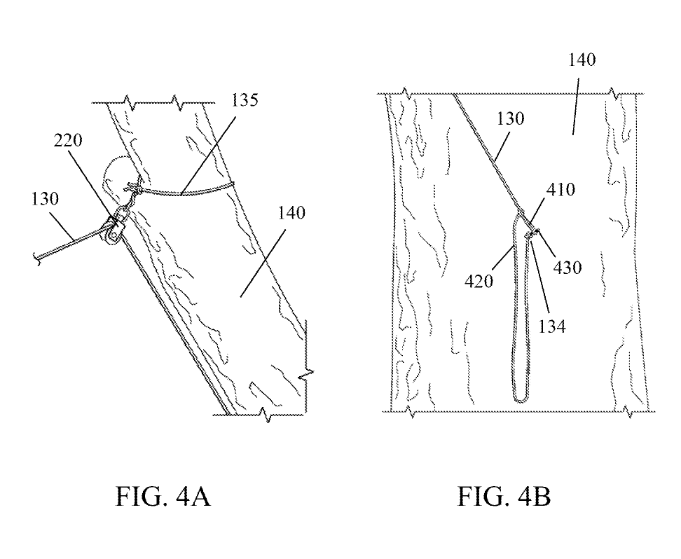

FIG. 4A shows a pulley 220 secured to a second fixed structure 140 in accordance with one or more embodiments of the present invention. In certain embodiments, a third cord 135 may be used to secure a second cord 130 to the second fixed structure 140. The third cord 135 may have a length selected such that the third cord 135 may be wrapped around and secured to the second fixed structure 140. The third cord 135 may be wrapped around the second fixed structure 140 and a first end (not independently illustrated) of the third cord and a second end (not independently illustrated) of the third cord may be secured to a mount disposed on a pulley 220. The first end (not shown) of the second cord 130 may be threaded through pulley 220.

Continuing in FIG. 4B, after the first end 134 of the second cord 130 is threaded through the pulley (220 of FIG. 4A), an attachment loop 410 may be formed out of a portion of the second cord 130 that is a predetermined length of slack 420 away from the first end 134 of the second cord 130. The first end 134 of the second cord 130 may be secured to a mount 430 disposed on the second fixed structure 140. The mount disposed on the first fixed structure 120 may include, for example, a nail 430, a screw (not shown), or hook (not shown). One of ordinary skill in the art will recognize that other mounts 430 may be disposed on the second fixed structure 140 in accordance with one or more embodiments of the present invention. The attachment loop 410 may be used to let out or pull in slack 420 such that the bird feeder (105 of FIG. 1) may be lowered or raised respectively. In FIG. 4B, the attachment loop 410 is shown secured to mount 430 disposed on the second fixed structure 140. This corresponds to the bird feeder (105 of FIG. 1) being in the raised, or normal bird feeding, position.

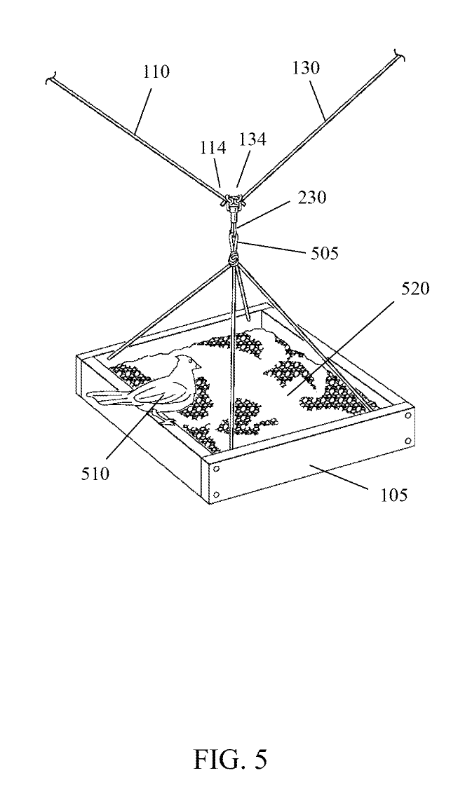

FIG. 5 shows a first cord 110 and a second cord 130 secured to a bird feeder 105 in accordance with one or more embodiments of the present invention. In certain embodiments, the second end 114 of the first cord 110 and the second end 134 of the second cord 130 may be secured to a mount of snap hook 230. Snap hook 230 may be secured to mount 505 disposed on, or integrated into, bird feeder 105. The use of snap hook 230 may facilitate swapping out bird feeder 105 for another bird feeder (not shown) or hanging object. In other embodiments, the second end 114 of the first cord 110 and the second end 134 of the second cord 130 may be secured directly to mount 505 disposed on, or integrated into, bird feeder 105. In the embodiment depicted in FIG. 5, bird feed 520 may be placed on a base of bird feeder 105 to attract one or more wild birds 510.

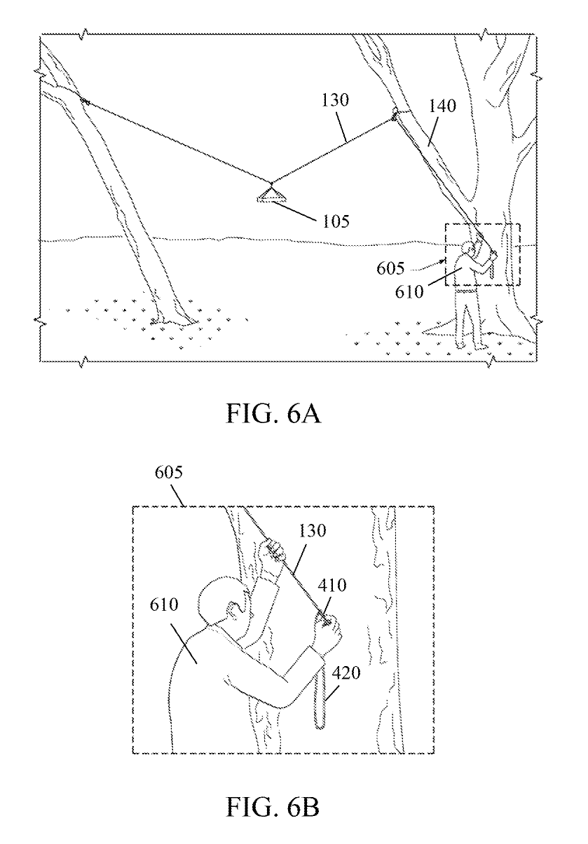

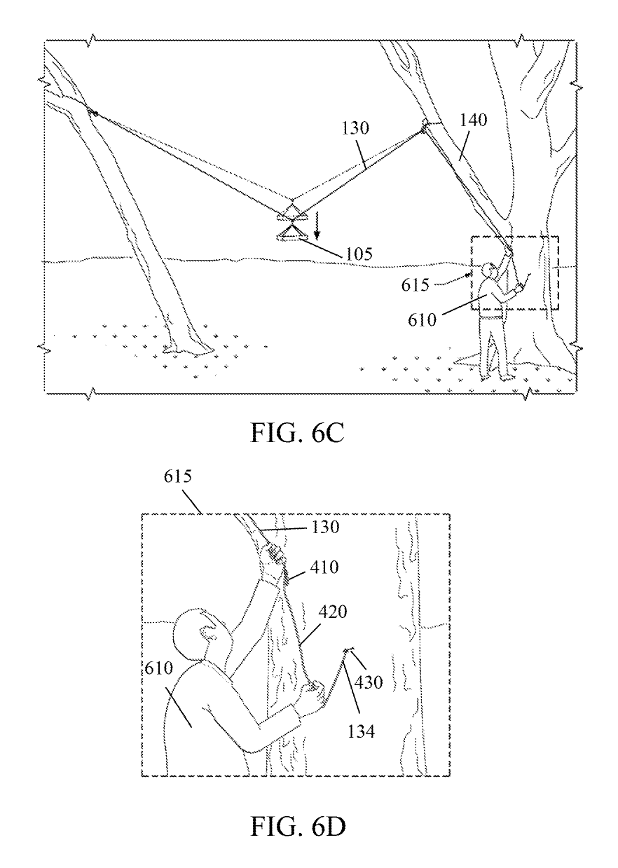

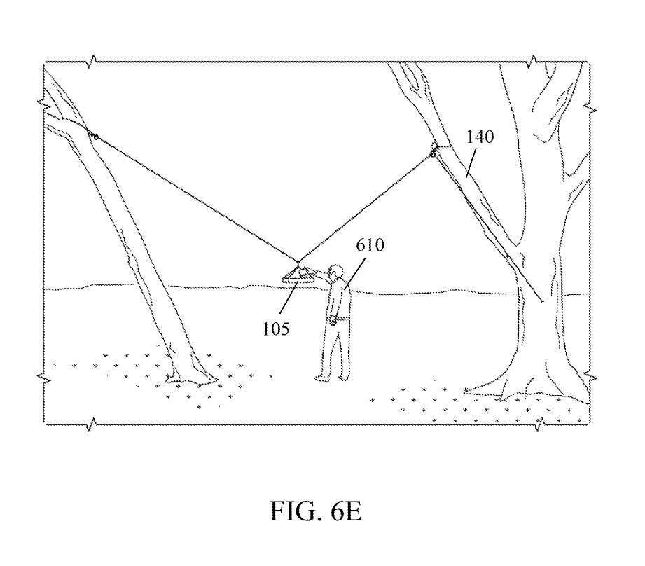

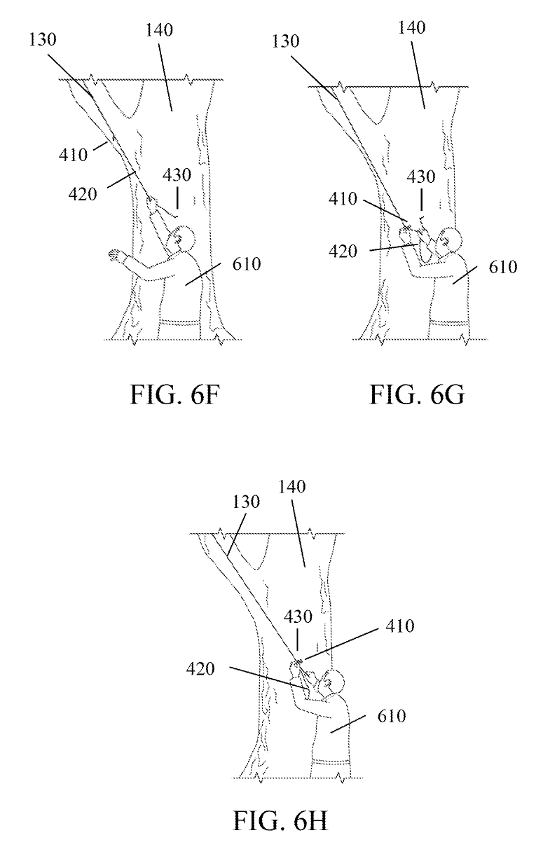

FIG. 6A shows a user 610 starting the process of lowering a bird feeder 105 in accordance with one or more embodiments of the present invention. Because of the clearance requirements discussed above, during typical feeding operations, bird feeder 105 may be positioned at a height that does not allow easy access to bird feeder 105. If the user 610 wants to replenish bird feed or swap out bird feeder 105 for another, bird feeder 105 may be lowered by releasing slack from the second cord 130.

FIG. 6B shows a zoomed in view 605 of a user 610 starting the process of lowering a bird feeder 105 in accordance with one or more embodiments of the present invention. If the user 610 wishes to lower bird feeder 105, the user 610 may remove the attachment loop 410 of a second cord 130 from the mount (not shown) disposed on the second fixed structure 140.

FIG. 6C shows a user 610 letting out a predetermined length of slack to lower a bird feeder 105 in accordance with one or more embodiments of the present invention. After the user 610 has removed the attachment loop 410 from the mount 430 disposed on the second fixed structure 140, the user 610 may let out a predetermined length of slack 420, thereby lowering bird feeder 105.

FIG. 6D shows a zoomed in view 615 of a user 610 letting out a predetermined length of slack to lower a bird feeder (105 of FIG. 6C) in accordance with one or more embodiments of the present invention. The predetermined length of slack 420 allows a portion of second cord 130 to move through the pulley (220 of FIG. 4A), thereby lowering bird feeder (105 of FIG. 6C) closer to the ground. The predetermined length of slack 420 may vary based on an application or design. The predetermined length of slack 420 may have a length suitable to lower bird feeder (105 of FIG. 6C) from its desired location when in the raised, or normal bird feeding, position, with the associated clearances, to a lowered location that provides easy access. Because the height of the desired location and the height of the lowered location may vary based on an application or design, the predetermined length of slack 420 may also vary. The predetermined length of slack 420 may be selected to ensure that the bird feeder (105 of FIG. 6C) may be lowered from the desired location such that the user 610 may reach the bird feeder (105 of FIG. 6C) when it is in its lowered position.

FIG. 6E shows a user 610 replenishing bird feed in a lowered bird feeder 105 in accordance with one or more embodiments of the present invention. Once lowered, the user 610 may replenish bird feed (520 of FIG. 5) in bird feeder 105 or swap out bird feeder 105 for another (not independently illustrated) or other hanging object (not shown). Because bird feeder 105 has been lowered, the user 610 may safely perform these tasks without a ladder.

FIG. 6F shows a user 610 starting the process of raising a bird feeder (not shown) in accordance with one or more embodiments of the present invention. After servicing bird feeder 105, the user 610 may wish to raise bird feeder 105 to its desired location. The user 610 may pull in the predetermined length of slack 420 by pulling on the second cord 130 in an area near the mount 430 disposed on the second fixed structure 140.

FIG. 6G shows a user 610 grasping an attachment loop 410 to raise a bird feeder (not shown) in accordance with one or more embodiments of the present invention. After pulling in the predetermined length of slack 420, the user 610 may grasp the attachment loop 410 in anticipation of securing the attachment loop 410 to the mount 430 disposed on the second fixed structure 140.

FIG. 6H shows a user 610 securing the attachment loop 410 to a second fixed structure 140 completing the process of raising the bird feeder (not shown) in accordance with one or more embodiments of the present invention. After grasping the attachment loop 410, the user 610 may secure the attachment loop 410 to the mount 430 disposed on the second fixed structure 140. The bird feeder 105 has been returned to its raised, or normal bird feeding, position, the desired location discussed in detail above.

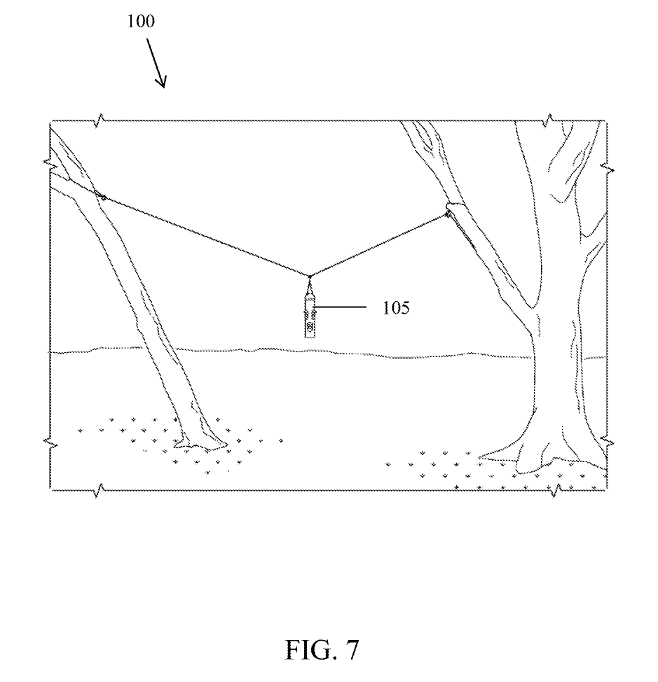

FIG. 7 shows a squirrel-proof bird feeder 100 in accordance with one or more embodiments of the present invention. Squirrel-proof bird feeder 100 of the present invention may be compatible with any conventional hanging bird feeder 105. However, advantageously, because of the effectiveness of squirrel-proof bird feeder 100, hanging bird feeders that are more open and less restrictive may be used without threat of squirrels pilfering bird feed.

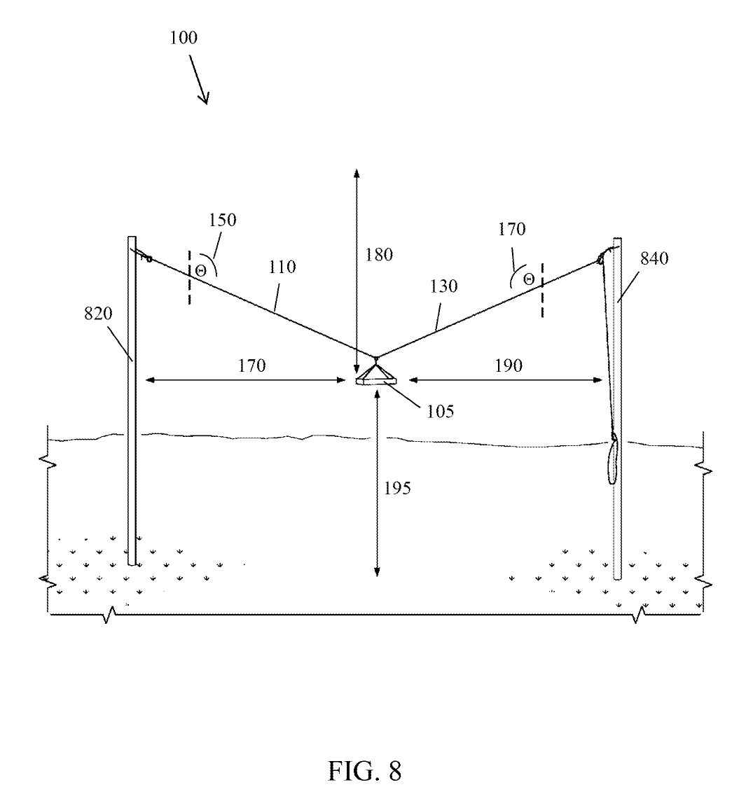

FIG. 8 shows a squirrel-proof bird feeder 100 using a first pole 820 as a first fixed structure (120 of FIG. 1) and a second pole 840 as a second fixed structure (140 of FIG. 1) in accordance with one or more embodiments of the present invention. In certain embodiments, a first pole 820 may be used as the first fixed structure (120 of FIG. 1) and a second pole 840 may be used as the second fixed structure (140 of FIG. 1). In certain embodiments, a first cord 110 may be secured to first pole 820 using the same mechanisms discussed above with respect to the first fixed structure (120 of FIG. 1). Similarly, a second cord 130 may be secured to second pole 840 using the same mechanisms discussed above with respect to the second fixed structure (140 of FIG. 1). However, in other embodiments, a first cord 110 may be secured directly to first pole 820 and a second cord 130 may be secured directly to second pole 840. One of ordinary skill in the art will recognize that any suitable mechanism for securing the first cord 110 and the second 130 to the first pole 820 and the second pole 840 respectively may be used in accordance with one or more embodiments of the present invention.

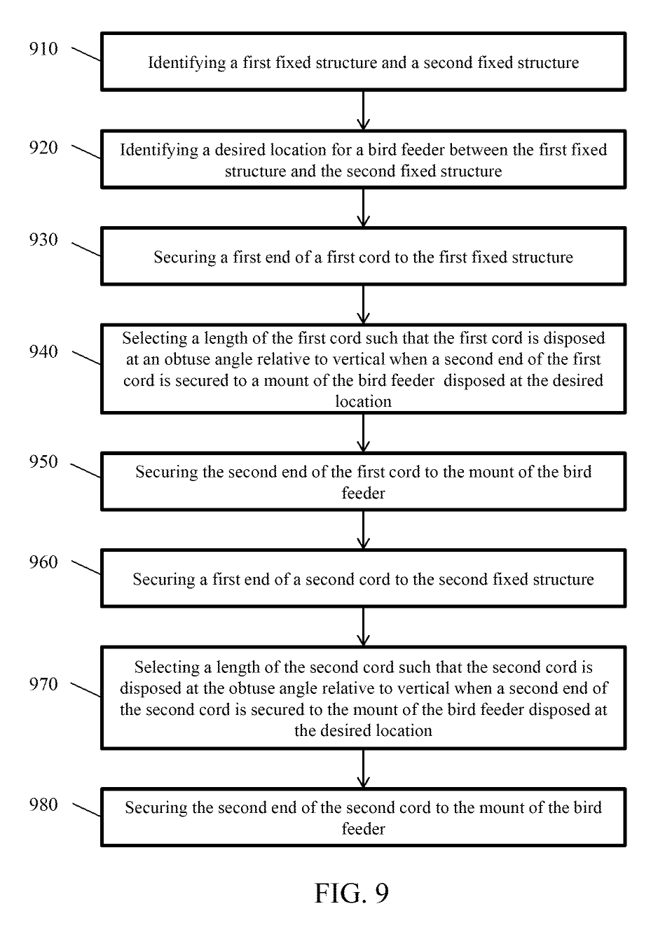

FIG. 9 shows a method of squirrel-proofing a bird feeder in accordance with one or more embodiments of the present invention. In step 910, a first fixed structure and a second fixed structure may be identified. In certain embodiments, the first fixed structure may be a tree, shrub, or limb. In other embodiments, the first fixed structure may be a pole or stationary object. One of ordinary skill in the art will recognize that other fixed structures may be used in accordance with one or more embodiments of the present invention. In certain embodiments, the second fixed structure may be a tree, shrub, or limb. In other embodiments, the second fixed structure may be a pole or stationary object. One of ordinary skill in the art will recognize that other fixed structures may be used in accordance with one or more embodiments of the present invention. One of ordinary skill in the art will also recognize that a combination of different types of fixed structures may be used in accordance with one or more embodiments of the present invention.

In step 920, a desired location for a bird feeder in between the first fixed structure and the second fixed structure may be identified. The bird feeder may be disposed at the desired location that includes a minimum lateral clearance from each fixed structure. In certain embodiments, the bird feeder may be disposed at the desired location that includes a minimum lateral clearance from each fixed structure of approximately 10 feet. In other embodiments, the bird feeder may be disposed at the desired location that includes a minimum lateral clearance from each fixed structure in a range between approximately 8 feet and approximately 12 feet. In still other embodiments, the bird feeder may be disposed at the desired location that includes a minimum lateral clearance from each fixed structure in a range between approximately 6 feet and approximately 12 feet. The desired location includes a minimum radial clearance around the bird feeder. In certain embodiments, the bird feeder may be disposed at the desired location that includes a minimum radial clearance around the bird feeder of approximately 5 feet. In other embodiments, the bird feeder may be disposed at the desired location that includes a minimum radial clearance around the bird feeder in a range between approximately 4 feet and approximately 6 feet. In still other embodiments, the bird feeder may be disposed at the desired location that includes a minimum radial clearance around the bird feeder in a range between approximately 6 feet and approximately 10 feet.

In step 930, a first end of a first cord may be secured to the first fixed structure. In certain embodiments, a ring may be attached to the first end of the first cord. The first end of the first cord may then be wrapped around the first fixed structure. A second end of the first cord may be threaded through the ring. The second end of the first cord may be pulled through the ring until the first cord is secured to the first fixed structure. In other embodiments, the first end of the first cord may be secured directly to the first fixed structure. One of ordinary skill in the art will recognize that the first end of the first cord may be secured to the first fixed structure in other ways in accordance with one or more embodiments of the present invention.

In step 940, a length of the first cord may be selected such that the first cord is disposed at an obtuse angle relative to vertical when a second end of the first cord is secured to a mount of the bird feeder, when it is disposed in the desired location. In certain embodiments, the obtuse angle may be an angle of approximately 150 degrees. In other embodiments, the obtuse angle may be an angle in a range between approximately 145 degrees and approximately 155 degrees. In still other embodiments, the obtuse angle may be an angle in a range between approximately 155 degrees and approximately 165 degrees. In still other embodiments, the obtuse angle may be an angle in a range between approximately 165 degrees and approximately 175 degrees.

In step 950, the second end of the first cord may be secured to a mount disposed on, or integrated into, the bird feeder. In certain embodiments, the second end of the first cord may be secured to a mount of a snap hook that is secured to the mount disposed on the bird feeder. In other embodiments, the second end of the first cord may be secured directly to the mount disposed on, or integrated into, the bird feeder. One of ordinary skill in the art will recognize that the second end of the first cord may be secured to the bird feeder in other ways in accordance with one or more embodiments of the present invention.

In step 960, a first end of the second cord may be secured to the second fixed structure. In certain embodiments, the first end of the second cord may be secured to the second fixed structure through a mounted pulley system. A length of a third cord may be selected such that the third cord may be wrapped around and secured to the second fixed structure. The third cord may be wrapped around the second fixed structure. A first end of the third cord and a second end of the third cord may be secured to a mount of the pulley. The first end of the second cord may be threaded through the pulley. The first end of the second cord may be secured to the mount disposed on the second fixed structure, securing it in place.

In other embodiments, the first end of the second cord may be wrapped around and secured to the second fixed structure through a mounted pulley system. A length of a third cord may be selected such that the third cord may be secured to the second fixed structure. The third cord may be wrapped around the second fixed structure. A first end of the third cord may be threaded through the pulley. An attachment loop may be formed out of a portion of the second cord a predetermined length of slack away the first end of the second cord. The first end of the second cord is then secured to a mount disposed on the second fixed structure. If a user wishes to lower the bird feeder, the user removes the attachment loop from the mount disposed on the second fixed structure and lets out the slack. If the user wishes to raise the bird feeder, the user pulls in the slack and attaches the attachment loop to the mount disposed on the second fixed structure. In still other embodiments, the first end of the second cord may be secured directly to a mount disposed on the second fixed structure. One of ordinary skill in the art will recognize that the first end of the second cord may be secured to the second fixed structure in other ways in accordance with one or more embodiments of the present invention.

In step 970, a length of the second cord may be selected such that the second cord is disposed at the obtuse angle relative to vertical when a second end of the second cord is secured to the mount of the bird feeder, when it is disposed in the desired location. In certain embodiments, the obtuse angle may be an angle of approximately 150 degrees. In other embodiments, the obtuse angle may be an angle in a range between approximately 145 degrees and approximately 155 degrees. In still other embodiments, the obtuse angle may be an angle in a range between approximately 155 degrees and approximately 165 degrees. In still other embodiments, the obtuse angle may be an angle in a range between approximately 165 degrees and approximately 175 degrees.

In step 980, the second end of the second cord may be secured to the mount disposed on, or integrated into, the bird feeder. In certain embodiments, the second end of the second cord may be secured to the mount of the snap hook that is secured to the mount disposed on, or integrated into, the bird feeder. In other embodiments, the second end of the second cord may be secured directly to the mount disposed on the bird feeder. One of ordinary skill in the art will recognize that the second end of the second cord may be secured to the bird feeder in other ways in accordance with one or more embodiments of the present invention.

Advantages of one or more embodiments of the present invention may include one or more of the following:

In one or more embodiments of the present invention, a method of squirrel-proofing a bird feeder may use at least two cord segments to dispose the bird feeder in a desired location between two fixed structures with minimum clearances. The cords are not taut and are each disposed at an obtuse angle relative to vertical when secured to the bird feeder, forming a substantially V-shape. The lack of tautness and the obtuse angles prevents squirrels from traversing the cord segments.

In one or more embodiments of the present invention, a method of squirrel-proofing a bird feeder disposes a bird feeder in a desired location in between two fixed structures with a minimum lateral clearance from each fixed structure and a minimum radial clearance around the bird feeder. The minimum lateral clearance from each fixed structure prevents squirrels from jumping from either fixed structure or other landings onto the bird feeder. The minimum radial clearance around the bird feeder prevents squirrels from jumping from the ground or a landing onto the bird feeder and prevents squirrels from jumping from higher ground down onto the bird feeder.

In one or more embodiments of the present invention, a method of squirrel-proofing a bird feeder takes advantage of the behavioral and physical characteristics of squirrels to prevent access to bird feed disposed in the bird feeder.

In one or more embodiments of the present invention, a method of squirrel-proofing a bird feeder is inexpensive, simple to install, and easy to maintain.

In one or more embodiments of the present invention, a method of squirrel-proofing a bird feeder is compatible with existing hanging bird feeders.

In one or more embodiments of the present invention, a method of squirrel-proofing a bird feeder provides a safe alternative to raising and lowering the bird feeder that does not require a ladder.

In one or more embodiments of the present invention, a method of squirrel-proofing a bird feeder allows for the use of more open bird feeders, that do not include housings to protect the bird feed. As a consequence, the bird viewing experience is heightened.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of squirrel-proofing a bird feeder comprising:
identifying a first fixed structure and a second fixed structure;
identifying a desired location for a bird feeder in between the first fixed structure and the second fixed structure;
securing a first end of a first cord to the first fixed structure;
selecting a length of the first cord such that the first cord is disposed at an obtuse angle relative to vertical when a second end of the first cord is secured to a mount of the bird feeder disposed at the desired location;
securing the second end of the first cord to the mount of the bird feeder;
securing a first end of a second cord to the second fixed structure;
selecting a length of the second cord such that the second cord is disposed at the obtuse angle relative to vertical when a second end of the second cord is secured to the mount of the bird feeder disposed at the desired location; and
securing the second end of the second cord to the mount of the bird feeder.

2. The method of claim 1,
wherein the bird feeder disposed at the desired location includes a minimum lateral clearance from each fixed structure in a range between approximately 8 feet and approximately 12 feet; and
wherein the bird feeder disposed at the desired location includes a minimum radial clearance around the bird feeder in a range between approximately 4 feet and approximately 6 feet.

3. The method of claim 1, wherein the obtuse angle is an angle in a range between approximately 145 degrees and approximately 155 degrees.

4. The method of claim 1, wherein the obtuse angle is an angle in a range between approximately 155 degrees and approximately 165 degrees.

5. The method of claim 1, wherein the obtuse angle is an angle in a range between approximately 165 degrees and approximately 175 degrees.

6. The method of claim 1, wherein the first end of the first cord is secured to the first fixed structure by:
attaching a ring to the first end of the first cord;
wrapping the first end of the first cord around the first fixed structure;
threading the second end of the first cord through the ring; and
pulling the second end of the first cord through the ring until the first cord is secured to the first fixed structure.

7. The method of claim 1, wherein the first end of the second cord is secured to the second fixed structure by:
selecting a length of a third cord such that the third cord is secured to the second fixed structure;
wrapping the third cord around the second fixed structure;
securing a first end of the third cord and a second end of the third cord to a mount of a pulley;
threading the first end of the second cord through the pulley; and
securing the first end of the second cord to a mount disposed on the second fixed structure.

8. The method of claim 1, wherein the first end of the second cord is secured to the second fixed structure by:
securing a length of a third cord such that the third cord is secured to the second fixed structure;
wrapping the third cord around the second fixed structure;
securing a first end of the third cord and a second end of the third cord to a mount of a pulley;
threading the first end of the second cord through the pulley;
forming an attachment loop out of a portion of the second cord a predetermined length of slack away from the first end of the second cord;
securing the first end of the second cord to a mount disposed on the second fixed structure; and
securing the attachment loop of the second cord to the mount disposed on the second fixed structure.

9. The method of claim 8, wherein the bird feeder may be lowered by removing the attachment loop of the second cord from the mount disposed on the second fixed structure.

10. The method of claim 1, wherein the first cord and the second cord each have a gauge in a range between approximately 1/64 inch and approximately ¼ inch.

11. A squirrel-proof bird feeder comprising:
a bird feeder;
a first cord; and
a second cord,
wherein a first end of the first cord is secured to a first fixed structure and a second end of the first cord is secured to a mount of the bird feeder,
the first cord has a length selected such that the first cord is disposed at an obtuse angle relative to vertical when the second end of the first cord is secured to the mount of the bird feeder disposed at a desired location,
a first end of the second cord is secured to a second fixed structure and a second end of the second cord is secured to the mount of the bird feeder, and
the second cord has a length selected such that the second cord is disposed at the obtuse angle relative to vertical when the second end of the second cord is secured to the mount of the bird feeder disposed at the desired location.

12. The squirrel-proof bird feeder of claim 11, further comprising:
a ring attached to the first end of the first cord,
wherein the first end of the first cord is secured to the first fixed structure by wrapping the first end of the first cord around the first fixed structure, threading the second end of the first cord through the ring, and pulling the second end of the first cord through the ring until the first cord is secured to the first fixed structure.

13. The squirrel-proof bird feeder of claim 11, further comprising:
a third cord; and
a pulley;
wherein the third cord length is selected such that the third cord is secured to the second fixed structure by wrapping the third cord around the second fixed structure and securing a first end of the third cord and a second end of the third cord to a mount of the pulley,
wherein the second cord is threaded through the pulley and the first end of the second cord is secured to a mount disposed on the second fixed structure,
wherein the second cord includes an attachment loop disposed a predetermined length of slack away from the first end of the second cord, and
wherein the predetermined length of slack is selected such that the bird feeder may be lowered.

14. The squirrel-proof bird feeder of claim 11, further comprising:
a snap hook,
wherein the second end of the first cord is secured to a mount of the snap hook,
wherein the second end of the second cord is secured to the mount of the snap hook, and
wherein the snap hook is secured to the mount of the bird feeder.

15. The squirrel-proof bird feeder of claim 11, wherein the first cord and the second cord each have a gauge in a range between approximately 1/64 inch and approximately ¼ inch.

16. The squirrel-proof bird feeder of claim 11, wherein the obtuse angle is an angle in a range between approximately 145 degrees and approximately 155 degrees.

17. The squirrel-proof bird feeder of claim 11, wherein the obtuse angle is an angle in a range between approximately 155 degrees and approximately 165 degrees.

18. The squirrel-proof bird feeder of claim 11, wherein the obtuse angle is an angle in a range between approximately 165 degrees and approximately 175 degrees.

19. The squirrel-proof bird feeder of claim 11, wherein the first fixed structure is a first tree and the second fixed structure is a second tree.

20. The squirrel-proof bird feeder of claim 11, wherein the first fixed structure is a first pole and the second fixed structure is a second pole.
